(19) United States
(12) Patent Application Publication
(10) Pub. No.: US 2021/0150050 A1
(43) Pub. Date: May 20, 2021

(54) METHOD FOR PREVENTING INFORMATION FROM BEING STOLEN, STORAGE DEVICE, AND MOBILE TERMINAL

(71) Applicant: HuiZhou TCL Mobile Communication Co., Ltd., HuiZhou (CN)

(72) Inventors: Renjie FU, HuiZhou (CN); Xiangqin LI, HuiZhou (CN); Deming ZHAO, HuiZhou (CN)

(73) Assignee: HuiZhou TCL Mobile Communication Co., Ltd., HuiZhou (CN)

(21) Appl. No.: 16/624,307

(22) PCT Filed: Jul. 4, 2018
(86) PCT No.: PCT/CN2018/094521

§ 371 Date: Dec. 19, 2019

(30) Foreign Application Priority Data
Jul. 4, 2017 (CN) 201710536558.5

(51) Int. Cl. G06F 21/62

(52) U.S. Cl. CPC G06F 21/6245

(57) ABSTRACT

A method for preventing information from being stolen includes: pre-establishing a sensitive character database in a mobile terminal; monitoring screen recording content when a screen recording function is activated by the mobile terminal; determining whether a sensitive character in the sensitive character database appears in the screen recording content; and if yes, the screen recording function is paused or a screen recording result is displayed by a black screen. A storage device and a mobile terminal are also provided.

This application claims the priority of Chinese Patent Application No. 201710536558.5, entitled “METHOD FOR PREVENTING INFORMATION FROM BEING STOLEN, STORAGE DEVICE, AND MOBILE TERMINAL”, filed on Jul. 4, 2017 in the CNIPA (National Intellectual Property Administration, PRC), the disclosure of which is incorporated herein by reference in its entirety.

### TECHNICAL FIELD

The present disclosure relates to a technology field of information security of mobile terminals, and more particularly to a method for preventing information from being stolen, a storage device, and a mobile terminal.

### BACKGROUND

With the development of scientific techniques, functions of mobile terminals are increasingly powerful. For the convenience of user, relationships between more and more personal information of users and mobile terminals are established. For example, the personal information, such as accounts of bank cards and various accounts and passwords of payments, are connected to the mobile terminals. When users have convenience of user, a potential problem that the information is stolen exists as well.

Consequently, the prior art needs to be improved and developed.

### SUMMARY OF DISCLOSURE

Embodiments of the present disclosure provides a method for preventing information from being stolen, a storage device, and a mobile terminal capable of solving the problem in the prior art that personal information is easily stolen when a backend of a mobile terminal performs a screen recording function.

In a first aspect, an embodiment of the present disclosure provides a method for preventing information from being stolen, wherein the method includes:

pre-establishing a sensitive character database in a mobile terminal;

monitoring screen recording content when a screen recording function is activated by the mobile terminal;

determining whether a sensitive character in the sensitive character database appears in the screen recording content; and if yes, the screen recording function is paused or a screen recording result is displayed by a black screen.

In the method for preventing the information from being stolen, the sensitive character includes at least one of numerals, letters, and Chinese characters.

In the method for preventing the information from being stolen, the step of monitoring the screen recording content when the screen recording function is activated by the mobile terminal specifically includes:

detecting, by a backend, whether the mobile terminal activates the screen recording function; and

when it is detected that the mobile terminal activates the screen recording function, the screen recording content is monitored in real time.

In the method for preventing the information from being stolen, the step of determining whether the sensitive character in the sensitive character database appears in the screen recording content and the step of pausing the screen recording function or displaying the screen recording result by the black screen if yes specifically include:

acquiring the screen recording content which is monitored; and

comparing the screen recording content to the sensitive character in the sensitive character database; when the sensitive character in the sensitive character database appears in the screen recording content, the screen recording function is paused or the screen recording result is displayed by the black screen.

In the method for preventing the information from being stolen, a method for activating the screen recording function is an active activating method or a passive activating method; when the method for activating the screen recording function is the passive activating method, a warning is generated.

In a second aspect, an embodiment of the present disclosure provides a storage device, including instructions stored therein, wherein the instructions are suitable for being loaded by a processor to execute:

pre-establishing a sensitive character database in a mobile terminal;

monitoring screen recording content when a screen recording function is activated by the mobile terminal;

determining whether a sensitive character in the sensitive character database appears in the screen recording content; and if yes, the screen recording function is paused or a screen recording result is displayed by a black screen.

In the storage device including the instructions stored therein, wherein the instructions are suitable for being loaded by the processor to execute:

detecting, by a backend, whether the mobile terminal activates the screen recording function; and

when it is detected that the mobile terminal activates the screen recording function, the screen recording content is monitored in real time.

In the storage device including the instructions stored therein, wherein the instructions are suitable for being loaded by the processor to execute:

acquiring the screen recording content which is monitored; and

comparing the screen recording content to the sensitive character in the sensitive character database; and when the sensitive character in the sensitive character database appears in the screen recording content, the screen recording function is paused or the screen recording result is displayed by the black screen.

In the storage device including the instructions stored therein, wherein the instructions are suitable for being loaded by the processor to execute:

generating a warning when a method for activating the screen recording function is a passive activating method.

In a third aspect, an embodiment of the present disclosure provides a mobile terminal including a processor configured to implement instructions; and a storage device including the instructions stored therein, wherein the instructions are suitable for being loaded by the processor to execute steps of:

pre-establishing a sensitive character database in the mobile terminal;

monitoring screen recording content when a screen recording function is activated by the mobile terminal;

determining whether a sensitive character in the sensitive character database appears in the screen recording content; and if yes, the screen recording function is paused or a screen recording result is displayed by a black screen; and

continuing the screen recording function when a page not including the sensitive character is switched to.

In the mobile terminal, the sensitive character includes at least one of numerals, letters, and Chinese characters.

In the mobile terminal, the step of monitoring the screen recording content when the screen recording function is activated by the mobile terminal specifically includes:

detecting, by a backend, whether the mobile terminal activates the screen recording function; and

when it is detected that the mobile terminal activates the screen recording function, the screen recording content is monitored in real time.

In the mobile terminal, wherein the step of determining whether the sensitive character in the sensitive character database appears in the screen recording content and the step of pausing the screen recording function or displaying the screen recording result by the black screen if yes specifically include:

acquiring the screen recording content which is monitored; and

comparing the screen recording content to the sensitive character in the sensitive character database; when the sensitive character in the sensitive character database appears in the screen recording content, the screen recording function is paused or the screen recording result is displayed by the black screen.

In the mobile terminal, a method for activating the screen recording function is an active activating method or a passive activating method; when the method for activating the screen recording function is the passive activating method, a warning is generated.

In the mobile terminal, the step of generating the warning when the method for activating the screen recording function is the passive activating method specifically includes:

popping up, by the mobile terminal, a dialogue box to generate the warning to remind the user that the backend of the mobile terminal performs the screen recording function, when the method for activating the screen recording function is the passive activating method.

In the method for preventing the information from being stolen, the storage device, and the mobile terminal provided by the present disclosure, the sensitive character database is pre-established in the mobile terminal. The screen recording content is monitored when the screen recording function is activated by the mobile terminal. It is determined whether the sensitive character in the sensitive character database appears in the screen recording content. If yes, the screen recording function is paused or the screen recording result is displayed by the black screen, so as to avoid the problem that the key personal information of the user is stolen.

### BRIEF DESCRIPTION OF DRAWINGS

FIG. 1 illustrates a flow chart of a method for preventing information from being stolen in accordance with a preferred embodiment of the present disclosure.

FIG. 2 illustrates a block diagram of a storage device in accordance with a preferred embodiment of the present disclosure.

FIG. 3 illustrates a block diagram of a mobile terminal in accordance with an embodiment of the present disclosure.

### DETAILED DESCRIPTION OF EMBODIMENTS

The present disclosure provides a method for preventing information from being stolen, a storage device, and a mobile terminal. To make the objectives, technical schemes, and technical effect of the present disclosure more clearly and definitely, the present disclosure will be described in details below by using embodiments in conjunction with the appending drawings. It should be understood that the specific embodiments described herein are merely for explaining the present disclosure but not intended to limit the present disclosure.

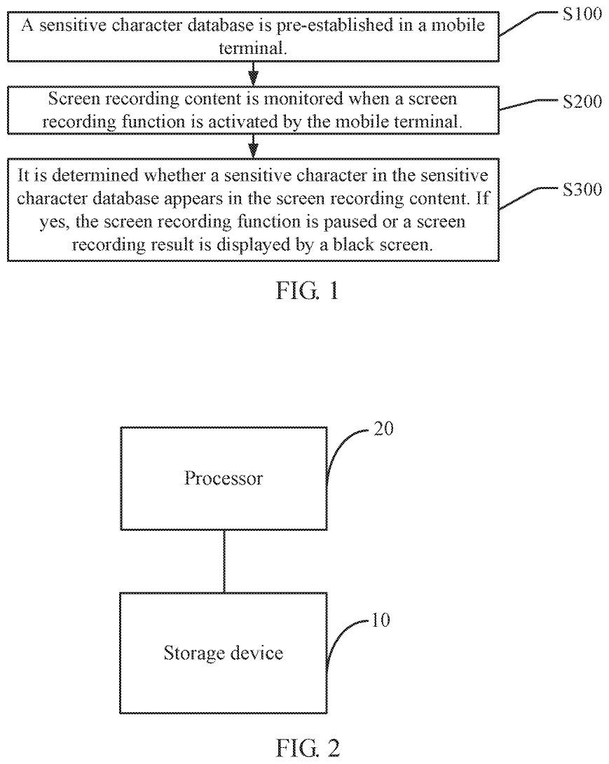

Please refer to FIG. 1. FIG. 1 illustrates a flow chart of a method for preventing information from being stolen in accordance with a preferred embodiment of the present disclosure. As shown in FIG. 1, the method for preventing the information from being stolen is suitable for being executed in a computing device and includes the following steps.

In step S100, a sensitive character database is pre-established in a mobile terminal.

In step S200, screen recording content is monitored when a screen recording function is activated by the mobile terminal.

In step S300, it is determined whether a sensitive character in the sensitive character database appears in the screen recording content. If yes, the screen recording function is paused or a screen recording result is displayed by a black screen.

In the embodiment of the present disclosure, when a backend of the mobile terminal performs the screen recording function, each operating step inputted by a user is recorded. If the screen recording content is acquired by others, an account and a password inputted by the user will be stolen by others easily. The present disclosure provides the method for preventing the information from being stolen. In the method, the sensitive character database is pre-established in the mobile terminal first. When the screen recording function is activated by the mobile terminal, the screen recording content is monitored. It is determined whether the sensitive character in the sensitive character database appears in the screen recording content. If yes, the screen recording function is paused or the screen recording result is displayed by the black screen. As such, the problem in the prior art that the personal information is easily stolen when the backend of the mobile terminal performs the screen recording function is solved.

Further, in the present disclosure, in step S100, the sensitive character includes at least one of numerals, letters, and Chinese characters.

In detail, the current key personal information involves: an identification card number and an account and a password of a bank including numerals; an account registered in the Internet and combining numerals and letters, e.g., a Weibo account or a Weixin account; and identification information when an input box appears in a page of the mobile terminal. Accordingly, defining the numerals, the letters, and the Chinese characters as the sensitive characters or vocabularies can monitor the content entirely, so as to prevent the information from being stolen preferably.

Further, in the present disclosure, step S200 specifically includes the following steps.

In step S201, the backend detects whether the mobile terminal activates the screen recording function.

In step S202, when it is detected that the mobile terminal activates the screen recording function, the screen recording content is monitored in real time.

By the above-mentioned steps, when the mobile terminal activates the screen recording function, the screen recording content can be monitored in real time to prevent the key information from being recorded, thereby preventing the personal information from being stolen.

Further, step S300 specifically includes the following steps.

In step S301, the screen recording content which is monitored is acquired.

In step S302, the screen recording content is compared to the sensitive character in the sensitive character database. When the sensitive character in the sensitive character database appears in the screen recording content, the screen recording function is paused or the screen recording result is displayed by the black screen.

In detail, when it is monitored that the sensitive character appears during a screen recording process, the screen recording function is paused immediately or the screen recording result is displayed by the black screen. When a page not including the sensitive character is switched to by the user, the screen recording function continues, thereby ensuring that the screen recording function can be performed normally and preventing the personal information from being stolen.

Further, in the present disclosure, a method for activating the screen recording function is an active activating method or a passive activating method. When the method for activating the screen recording function is the passive activating method, a warning is generated.

In detail, the method for activating the screen recording function is the active activating method in which the user executes a screen recording software to activate the screen recording function. The method for activating the screen recording function is the passive activating method in which a hacker activates the screen recording function by an ADB command. The ADB refers to “android debug bridge”. Currently, with the spreading of mobile terminal assistants, for example, mobile phone assistants, it is necessary to enable USB debug when a mobile phone assistant is used. When the user connects the mobile phone to a computer and the computer is hacked by the illegal hacker, the illegal hacker can use a simple command “adb shell screenrecord sdcard\11.mp4” to perform the screen recording function by the backend of the mobile phone.

When the method for activating the screen recording function is the passive activating method, the mobile terminal pops up a dialogue box to generate a warning to remind the user that the backend of the mobile terminal performs the screen recording function currently, so that the user can response in real time.

It should be noted that those skilled in the art may understand all or some of the processes in the methods of the embodiments described above can be realized by using programs to instruct corresponding hardware. The programs may be stored in a computer readable storage medium. The storage medium may include read-only memory (ROM), random access memory (RAM), disk, compact disc (CD), or the like.

Please refer to FIG. 2. FIG. 2 illustrates a block diagram of a storage device 10 based on the above-mentioned method and provided in accordance with a preferred embodiment of the present disclosure. As shown in FIG. 2, the storage device 10 includes instructions stored therein. The instructions are suitable for being loaded by a processor 20 to execute: pre-establishing a sensitive character database in a mobile terminal; monitoring screen recording content when a screen recording function is activated by the mobile terminal; determining whether a sensitive character in the sensitive character database appears in the screen recording content; and if yes, the screen recording function is paused or a screen recording result is displayed by a black screen.

Further, in the present disclosure, the instructions are suitable for being loaded by the processor 20 to execute: detecting, by a backend, whether the mobile terminal activates the screen recording function; and when it is detected that the mobile terminal activates the screen recording function, the screen recording content is monitored in real time.

Further, in the present disclosure, the instructions are suitable for being loaded by the processor 20 to execute: continuing the screen recording function when a page not including the sensitive character is switched to by a user.

Further, in the present disclosure, the instructions are suitable for being loaded by the processor 20 to execute: generating a warning when a method for activating the screen recording function is a passive activating method.

Further, as shown in FIG. 2, the present disclosure further provides a mobile terminal including the processor 20 and the storage device (memory) 10. The processor 20 and the storage device 10 implement communications therebetween via a bus.

The processor 20 is configured to call programs in the storage device 10 to perform the above-mentioned for preventing the information from being stolen. For example, the method includes: pre-establishing a sensitive character database in a mobile terminal; monitoring screen recording content when a screen recording function is activated by the mobile terminal; determining whether a sensitive character in the sensitive character database appears in the screen recording content; and if yes, the screen recording function is paused or a screen recording result is displayed by a black screen.

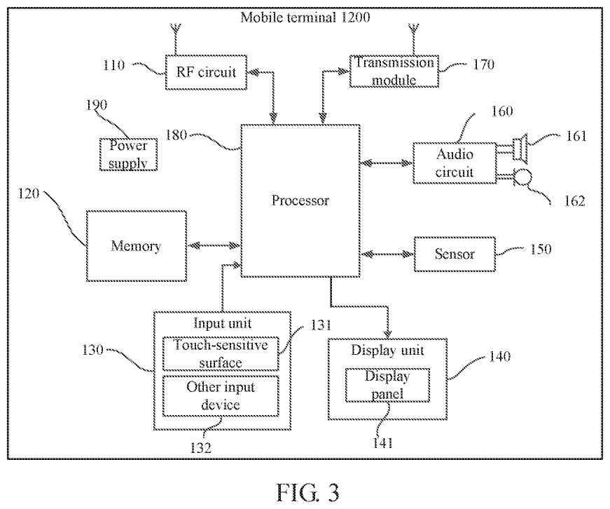

FIG. 3 illustrates a block diagram of a mobile terminal in accordance with an embodiment of the present disclosure. The mobile terminal may be used to implement the method for preventing the information from being stolen provided by the above-mentioned embodiment. The mobile terminal 1200 may be a smart phone or a tablet computer.

As shown in FIG. 3, the mobile terminal 1200 may include a radio frequency (RF) circuit 110, a memory 120 including one or more computer readable storage mediums (only one is shown in FIG. 3), an input unit 130, a display unit 140, at least one sensor 150, an audio circuit 160, a transmission module 170, a processor 180 including one or more processing cores (only one is shown in FIG. 3), a power supply 190 and the like. Those skilled in the art can understand that the mobile terminal 1200 is not limited to the structure shown in FIG. 3, and may include more or fewer parts than those shown in FIG. 3, or some parts may be combined, or different arrangement of parts may be adopted.

The RF circuit 110 is configured to receive and transmit electromagnetic waves and to realize conversions of the electromagnetic waves and electrical signals, thereby communicating with a communication network or any other device. The RF circuit may include various conventional circuit elements used for performing these functions, for example, an antenna, a radio frequency transmitter, a digital signal processor, an encryption/decryption chip, a subscriber identification module (SIM) card, a memory and the like. The RF circuit 1010 may communicate with various networks, for example, an internet, an intranet or a wireless network, or may communicate with any other device via a wireless network. The above-mentioned wireless network may include a cellular telephone network, a wireless local area network or a metropolitan area network. The above-mentioned wireless network may use various communication standards, protocols and technologies and may include but not limited to, Global System of Mobile Communication (GSM), Enhanced Data GSM Environment (EDGE), Wideband Code Division Multiple Access (WCDMA), Code Division Multiple Access (CDMA), Time Division Multiple Access (TDMA), Wireless Fidelity (Wi-Fi, for example, Institute of Electrical and Electronics Engineers (IEEE) 802.11a, IEEE 802.11b, IEEE 802.11g and/or IEEE 802.11n), Voice over Internet Protocol (VoIP) Worldwide Interoperability for Microwave Access (Wi-Max), other protocols for E-mail, instant messaging and Short Messaging Service (SMS) and other suitable communication protocols, and may include protocols which are not developed currently.

The memory 120 may be configured to store software programs and software modules, for example, the program instructions/modules corresponding to the method and system for remotely controlling the smart television based on the mobile terminal in accordance with the above-mentioned embodiments. The processor 180 executes various functional applications and data processing by operating the software programs and the software modules stored in the memory 120. The memory 120 may include a high speed random access memory and also may include a non-volatile memory, such as one or more disk storage devices, a flash memory device or other non-volatile solid storage devices. In some embodiments, the memory 120 may further include a remote memory disposed corresponding to the processor 180. The remote memory may be connected to the mobile terminal 1200 via a network. Examples of the network include but are not limited to an internet, an intranet, a local area network, a mobile communication network and the combinations of them.

The input unit 130 may be configured to receive input number or character information and to generate keyboard, mouse, joystick, optical or trajectory ball signal inputs related to a user's setting and functional control. In detail, the input unit 130 may include a touch-sensitive surface 131 and other input device 132. The touch-sensitive surface 131, also called a touch display screen or a touch panel, may be configured to detect touch operations of a user on or near the touch-sensitive surface 131 (for example, operations carried out by the user through any suitable objects or attachments, such as a finger, a touch pen and the like, on the touch-sensitive surface 131 or near the touch control panel 1031) and to drive a corresponding device connected therewith according to a preset program. Optionally, the touch-sensitive surface 131 may include a touch detection device and a touch controller. The touch detection device detects the touch direction of the user, detects a signal caused by the touch operation and transmits the signal to the touch controller. The touch controller receives touch information from the touch detection device, converts the touch information into a contact coordinate and then transmits the contact coordinate to the processor 180 and may receive a command transmitted by the processor 180 and execute the command. Moreover, the touch-sensitive surface 131 may be one of various types, such as a resistance type, a capacitance type, an infrared type, a surface acoustic wave type and the like. Besides the touch-sensitive surface 131, the input unit 130 also may include other input device 132. In detail, other input device 132 may include, but is not limited to, one or more of a physical keyboard, function keys (such as a volume control key, a switching key and the like), a trackball, a mouse, a joystick and the like.

The display unit 140 may be configured to display information input by the user or information provided for the user and various graphical user interfaces of the mobile terminal 1200. The graphical user interfaces may be constituted by graphics, texts, icons, videos and any combinations of them. The display unit 140 may include a display panel 141. Optionally, the display panel 141 may be configured in forms of a Liquid Crystal Display (LCD), an Organic Light-Emitting Diode (OLED) and the like. Furthermore, the touch panel 131 may cover the display panel 141. When the touch-sensitive surface 131 detects a touch operation on or near it, the signal caused by the touch operation is transmitted to the processor 180 to determine the type of a touch event. Then, the processor 180 provides a corresponding visual output on the display panel 141 according to the type of the touch event. In FIG. 3, the touch-sensitive surface and the display panel 141 are served as two independent parts for accomplishing input and output functions, however, in some embodiments, the touch-sensitive surface 131 and the display panel 1041 may be integrated to accomplish the input and output functions.

The mobile terminal 1200 may further include at least one sensor 150, such as a gyroscope sensor, a magnetic induction sensor, an optical sensor, a motion sensor and other sensors. In detail, the optical sensor may include an environmental light sensor and a proximity sensor. The environmental light sensor may adjust brightness of the display panel 141 according to the lightness of environmental light. The proximity sensor may turn off the display panel 141 and/or backlight when the mobile terminal 1200 approaches an ear. As one type of the motion sensor, an accelerometer sensor may detect the value of an acceleration in each direction (generally in three axial directions), may detect the value and the direction of gravity in a static state, which may be used in posture identifying functions (such as switching between a horizontal screen and a vertical screen, switching related to a game, and calibration on the posture of a magnetometer), vibration identifying functions (such as for pedometer and striking) and the like. Furthermore, a gyroscope, a barometer, a humidity meter, a thermometer, an infrared sensor and other sensors may be integrated into the mobile terminal 1200, and explanations are not repeated herein.

The audio circuit 160, a speaker 161 and a microphone 162 may provide an audio interface between the user and the mobile terminal 1200. The audio circuit 160 may transmit an electric signal obtained by converting received audio data to the speaker 161. The electric signal is converted into a sound signal to be outputted by the speaker 161. On the other hand, the microphone 1062 converts a collected sound signal into an electric signal. The audio circuit 1060 receives the electric signal and converts the electric signal into audio data. After the audio data is outputted to the processor 180 and is processed, it is transmitted, for example, to another terminal through the RF circuit 110, or is outputted to the memory 120 in order to be further processed. The audio circuit 160 may further include an ear plug hole for providing communication between an external ear phone and the mobile terminal 1200.

The mobile terminal 1200 can help the user to receive and send E-mails, browse webpages, access streaming media and the like by the transmission module 170 (for example, a Wi-Fi module). The transmission module 170 provides wireless broadband internet access for the user. Although the transmission module 170 is shown in FIG. 3, it should be understood that the transmission module 170 is not the necessary part of the mobile terminal 1200 and may completely be omitted as required without changing the scope of the present disclosure.

The processor 180 is a control center of the mobile terminal 1200, is connected with all the parts of the whole mobile phone by various interfaces and lines and is configured to execute various functions of the mobile terminal 1200 and process the data by operating the software programs and/or the modules stored in the memory 120, and to call the data stored in the memory 120 so as to carry out integral monitoring on the mobile phone. Optionally, the processor 180 may include one or more processing cores. In some embodiments, the processor 180 may be integrated with an application processor and a modulation/demodulation processor. The application processor is mainly configured to process an operating system, at least one user interface, at least one application and the like. The modulation/demodulation processor is mainly configured to process wireless communication. It should be understood that the modulation/demodulation processor may also be not integrated into the processor 180.

The mobile terminal 1200 further includes the power supply 190 (such as a battery) for supplying power to each part. In some embodiments, the power supply may be logically connected with the processor 180 by a power supply management system, so as to implement functions of charge management, discharge management, power consumption management and the like by the power supply management system. The power supply 190 may further include one or more direct current or alternating current power supplies, recharging systems, power supply failure detection circuits, power converters or inverters, power supply status indicators and the like.

Although not shown in the FIG. 3, the mobile terminal 1200 may further include a camera (for example, a front camera or a rear camera), a BLUETOOTH module, and the like which are not further described herein. In the present embodiment, the display unit of the mobile terminal is a touch screen display, and the mobile terminal further includes a memory and one or more programs. The one or more programs are stored in the memory and configured to be executed by one or more processors. The one or more programs contain instructions for performing the following operations:

pre-establishing a sensitive character database in the mobile terminal;

monitoring screen recording content when a screen recording function is activated by the mobile terminal;

determining whether a sensitive character in the sensitive character database appears in the screen recording content; pausing the screen recording function or displaying a screen recording result by a black screen if yes; and

continuing the screen recording function when a page not including the sensitive character is switched to by a user.

In the mobile terminal, the sensitive character includes at least one of numerals, letters, and Chinese characters.

In the mobile terminal, the step of monitoring the screen recording content when the screen recording function is activated by the mobile terminal specifically includes:

detecting, by a backend, whether the mobile terminal activates the screen recording function; and

when it is detected that the mobile terminal activates the screen recording function, the screen recording content is monitored in real time.

In the mobile terminal, the step of determining whether the sensitive character in the sensitive character database appears in the screen recording content and the step of pausing the screen recording function or displaying the screen recording result by the black screen if yes specifically include:

acquiring the screen recording content which is monitored; and

comparing the screen recording content to the sensitive character in the sensitive character database; when the sensitive character in the sensitive character database appears in the screen recording content, the screen recording function is paused or the screen recording result is displayed by the black screen.

In the mobile terminal, a method for activating the screen recording function is an active activating method or a passive activating method. When the method for activating the screen recording function is the passive activating method, a warning is generated.

In the mobile terminal, the step of generating the warning when the method for activating the screen recording function is the passive activating method specifically includes:

popping up, by the mobile terminal, a dialogue box to generate the warning to remind the user that the backend of the mobile terminal performs the screen recording function, when the method for activating the screen recording function is the passive activating method.

In summary, in the method for preventing the information from being stolen, the storage device, and the mobile terminal provided by the present disclosure, the sensitive character database is pre-established in the mobile terminal. The screen recording content is monitored when the screen recording function is activated by the mobile terminal. It is determined whether the sensitive character in the sensitive character database appears in the screen recording content. If yes, the screen recording function is paused or the screen recording result is displayed by the black screen, so as to avoid the problem that the key personal information of the user is stolen.

It should be understood that present disclosure is not limited to the exemplary examples. Those skilled in the art in the art may achieve equivalent improvements or replacements according to the above description. The equivalent improvements and replacements should be considered to belong to the protection scope of the present disclosure.

1-15. (canceled)

16. A method for preventing information from being stolen, comprising:
pre-establishing a sensitive character database in a mobile terminal;
monitoring screen recording content when a screen recording function is activated by the mobile terminal;
determining whether a sensitive character in the sensitive character database appears in the screen recording content; and
in response to the sensitive character appearing in the screen recording content, pausing the screen recording function or displaying a screen recording result by a black screen.

17. The method for preventing the information from being stolen of claim 16, wherein the sensitive character comprises at least one of numerals, letters, and Chinese characters.

18. The method for preventing the information from being stolen of claim 16, wherein the step of monitoring the screen recording content when the screen recording function is activated by the mobile terminal comprises:
detecting, by a backend of the mobile terminal, whether the mobile terminal activates the screen recording function; and
when it is detected that the mobile terminal activates the screen recording function, the screen recording content is monitored in real time.

19. The method for preventing the information from being stolen of claim 16, wherein the step of determining whether the sensitive character in the sensitive character database appears in the screen recording content and the step of in response to the sensitive character appearing in the screen recording content, pausing the screen recording function or displaying the screen recording result by the black screen comprise:
acquiring the screen recording content which is monitored; and
comparing the screen recording content to the sensitive character in the sensitive character database;
in response to the sensitive character appearing in the screen recording content, pausing the screen recording function or displaying the screen recording result by the black screen.

20. The method for preventing the information from being stolen of claim 16, wherein a warning is generated by the mobile terminal when the screen recording function is performed by an android debug bridge (ADB) command.

21. The method for preventing the information from being stolen of claim 20, wherein the step of generating the warning comprises:
popping up, by the mobile terminal, a dialogue box to generate the warning to remind the user that a backend of the mobile terminal performs the screen recording function, when the screen recording function is performed by the ADB command.

22. A storage device, comprising instructions stored therein, wherein the instructions are loaded by a processor to execute:
pre-establishing a sensitive character database in a mobile terminal;
monitoring screen recording content when a screen recording function is activated by the mobile terminal;
determining whether a sensitive character in the sensitive character database appears in the screen recording content; and
in response to the sensitive character appearing in the screen recording content, pausing the screen recording function or displaying a screen recording result by a black screen.

23. The storage device of claim 22, wherein the sensitive character comprises at least one of numerals, letters, and Chinese characters.

24. The storage device of claim 22, wherein the instructions are loaded by the processor to execute:
detecting, by a backend of the mobile terminal, whether the mobile terminal activates the screen recording function; and
when it is detected that the mobile terminal activates the screen recording function, the screen recording content is monitored in real time.

25. The storage device of claim 22, wherein the instructions are loaded by the processor to execute:
acquiring the screen recording content which is monitored; and
comparing the screen recording content to the sensitive character in the sensitive character database; and
in response to the sensitive character appearing in the screen recording content, pausing the screen recording function or displaying the screen recording result by the black screen.

26. The storage device of claim 22, wherein the instructions are loaded by the processor to execute:
generating a warning when the screen recording function is performed by an android debug bridge (ADB) command.

27. The storage device of claim 26, wherein the instructions are loaded by the processor to execute:
popping up a dialogue box to generate the warning to remind the user that a backend of the mobile terminal performs the screen recording function, when the screen recording function is performed by the ADB command.

28. A mobile terminal, comprising:
a processor configured to implement instructions; and
a storage device comprising the instructions stored therein, wherein the instructions are loaded by the processor to execute steps of:
pre-establishing a sensitive character database in the mobile terminal;
monitoring screen recording content when a screen recording function is activated by the mobile terminal;
determining whether a sensitive character in the sensitive character database appears in the screen recording content; and
in response to the sensitive character appearing in the screen recording content, pausing the screen recording function or displaying a screen recording result by a black screen.

29. The mobile terminal of claim 28, wherein after the step of pausing the screen recording function or displaying the screen recording result by the black screen, the instructions are loaded by the processor to execute steps of:
continuing the screen recording function when a page not including the sensitive character is switched to.

30. The mobile terminal of claim 28, wherein the sensitive character comprises at least one of numerals, letters, and Chinese characters.

31. The mobile terminal of claim 28, wherein the step of monitoring the screen recording content when the screen recording function is activated by the mobile terminal comprises:
detecting, by a backend of the mobile terminal, whether the mobile terminal activates the screen recording function; and
when it is detected that the mobile terminal activates the screen recording function, the screen recording content is monitored in real time.

32. The mobile terminal of claim 28, wherein the step of determining whether the sensitive character in the sensitive character database appears in the screen recording content and the step of in response to the sensitive character appearing in the screen recording content, pausing the screen recording function or displaying a screen recording result by a black screen comprise:
acquiring the screen recording content which is monitored; and
comparing the screen recording content to the sensitive character in the sensitive character database;
in response to the sensitive character appearing in the screen recording content, pausing the screen recording function or displaying the screen recording result by the black screen.

33. The mobile terminal of claim 28, wherein a warning is generated by the mobile terminal when the screen recording function is performed by an android debug bridge (ADB) command.

34. The mobile terminal of claim 33, wherein the step of generating the warning comprises:
popping up, by the mobile terminal, a dialogue box to generate the warning to remind the user that a backend of the mobile terminal performs the screen recording function, when the screen recording function is performed by the ADB command.
